(19) United States
(12) Patent Application Publication
(10) Pub. No.: US 2005/0091905 A1
(43) Pub. Date: May 5, 2005

(54) Lighted fish landing net

(76) Inventors: Robert A. Larson, Austin, MN (US); Matt L. Larson, Albert Lea, MN (US)

Correspondence Address: JANSSON, SHUPE & MUNGER, LTD, 245 MAIN STREET, RACINE, WI, 53403, US

(21) Appl. No.: 10/699,519

(22) Filed: Oct. 31, 2003

(51) Int. Cl. A01K 77/00

(52) U.S. Cl. 43/17.5; 43/11

(57) ABSTRACT

A light adapted to be used with a fish landing net includes an LED illuminator, a base member structured to hold the LED, and a switch for connecting or disconnecting a circuit to the LED, where the base member is attachable to the fish landing net. A net light may have a switch disposed locally to the illuminator. The net may be collapsible. A net frame member may have a reflective tape or reflective coating surface opposed to the illuminator. The net may have reflective surfaces containing fluorescent pigment, optical filtering, in a pattern that replicates a fish-friendly environment, and/or in a pattern having a two-dimensional or three-dimensional spatial arrangement. A method includes adjusting or setting a light emission for avoiding scaring-away of fish. A method may include changing brightness of the illuminator. A method may include providing a positionable illuminator for changing a direction of the illumination pattern.

### BACKGROUND

1. Field of the Invention

The present invention is related to fishing equipment and, more particularly, to fish landing nets.

2. Description of the Related Art

Fishing is an activity having both commercial and sporting purposes. It is highly popular as an outdoor sport, largely because of the solitude (or companionship) and opportunity to enjoy natural scenic beauty which often attends such sport. Of course, the successful angler can look forward to a tasty meal.

And the sport has its economic aspects. Persons who enjoy fishing spend millions of dollars on fishing equipment. In some aspects of game fishing, e.g., lake fishing involving trolling or casting, participants go forth in boats laden with fishing gear of many types. Such gear may include heavy tackle boxes containing the latest lures, live bait containers, multiple fishing poles and, of course, a large landing net. Persons who outfit themselves in this way and who engage in this type of game fishing may find such activity practical only with a boat—there may be no other good way to transport and use the gear.

On the other hand, persons who fly-fish trout streams make it a point to minimize the amount of equipment to be carried and to buy equipment which is easy to pack, transport and use. It is not unusual for persons fishing for trout to fly to a site near their favorite location. And, of course, such air travelers know that it is desirable to minimize the weight and space needed for the fishing gear.

One of the potentially bulkiest but necessary items of equipment used by persons fishing for trout and similar fish is a landing net. In an effort to address the need for a compact yet effective net, folding, telescoping, and collapsible landing nets have been made available. Such nets have varying degrees of complexity and ease of use. Landing nets may also be available in various sizes, depending on convenience and on the size of a particular type of fish being sought. As with all fishing stories, a size may be exaggerated.

Many fishermen may find it desirable to fish at night. It may be much more difficult to land a fish with a net in the darkness, and it may not be practical to attempt to provide a lighting to the landing location. For example, a high intensity light typically uses a large amount of electricity and may disturb the ambience of the fishing location. Such a light may also scare away the fish being landed or other fish being sought by neighboring fishermen. It is not practical to attempt to hold a flashlight while simultaneously holding a fishing pole and/or the landing net. It is also not practical to use a lantern or similar light because it may do a poor job of lighting a desired area, attract bugs, disturb neighboring fishermen, etc.

An illuminated fishing net is disclosed in U.S. Pat. No. 4,800,667 granted to Johnson. However, such a net is not practical because it is not collapsible, not modular, and has a structure that is not adaptable or able to be optimized.

### OBJECTS OF THE INVENTION

It is an object of the invention to provide an improved fish landing net overcoming some of the problems and shortcomings of the prior art, including those referred to above.

Another object of the invention is to provide a modular lighting system in a portable fish landing net.

Another object of the invention is to provide a method and system for optimizing lighting used for landing a fish.

Still another object of the invention is to provide a light emitting diode (LED) type light that is adaptable to being used with a fish landing net.

Yet another object of the invention is to provide a system adaptable for illuminating a fish landing area in a manner that avoids or minimizes scaring-away of fish.

Another object of the invention is to provide a collapsible fish landing net having an illuminator.

How these and other objects are accomplished will become apparent from the following descriptions and the drawing figures.

### SUMMARY OF THE INVENTION

According to a first aspect of the invention, a light adapted to be used with a fish landing net includes at least one light emitting diode (LED), a base member structured to hold the LED, and a switch for connecting or disconnecting a circuit to the LED, where the base member is attachable to the fish landing net. The switch may be disposed locally to the base member.

In another aspect of the invention, a light adapted to be used with a fish landing net includes at least one LED, means for holding the LED, and means for switching a connection to the LED on or off.

In yet another aspect of the invention, fish landing apparatus include a net structure for landing fish and having an electric-powered illuminator, and a switch disposed locally to the illuminator.

In a further aspect of the invention, fish landing apparatus include a collapsible net for landing fish, the collapsible net including a handle member, and an electric-powered illuminator disposed in a distal end of the handle member.

In a still further aspect of the invention, a method facilitating the landing of fish includes providing apparatus that includes a net structure for landing fish and having an electric-powered illuminator, and a switch disposed locally to the illuminator, and changing a level of illumination of the illuminator from a first brightness level to a second brightness level.

In an additional aspect of the invention, a method facilitating the landing of fish includes providing apparatus that includes a net structure for landing fish and having an electric-powered illuminator, and a switch disposed locally to the illuminator, and adjusting a light emission of the apparatus for avoiding scaring-away of fish.

According to another aspect of the invention, a method facilitating the landing of fish includes providing apparatus that includes a net structure for landing fish and having an electric-powered illuminator, and a switch disposed locally to the illuminator, and setting a light emission of the apparatus for avoiding scaring-away of a particular type of fish.

According to another aspect of the invention, a method facilitating the landing of fish includes providing apparatus that includes a net structure for landing fish and having an electric-powered illuminator operable to emit light in a pattern, the illuminator being positionable for changing a direction of the pattern.

As a result of implementing some of the various aspects of the invention, fishermen may be more likely to fish at night since it becomes easier to land a fish with a net in the darkness. It becomes more practical to provide lighting to the landing location. In various applications an intensity or directivity of the light being emitted may be controlled by a fisherman. The light being provided may be enhanced or otherwise modified by use of various reflective materials in combination with different light sources, for example, by utilizing various types of LEDs. A desired lighting is provided with a relatively low amount of electricity, and without disturbing the ambience of the fishing location. It is also possible to use a light without increasing disturbance to the fish being landed and/or without scaring away other fish being sought by neighboring fishermen. The lighting effect and direction may be customized by the fisherman by providing an LED lighting device adaptable to different conditions and fishing environments. The invention is intended to provide advantages for both sport fishing and commercial fishing.

Additional advantages and a more complete understanding of the present invention may be derived by referring to the detailed description of preferred embodiments and claims when considered in connection with the figures, wherein like reference numbers refer to similar items throughout the figures.

### BRIEF DESCRIPTION OF THE DRAWINGS

FIG. 1 shows an assembled LED light structure according to an exemplary embodiment of the invention.

FIG. 2 is a view showing main components of the FIG. 1 embodiment.

FIG. 3 is an exploded view of the FIG. 1 embodiment.

FIGS. 4A-C respectively show a top view, side view, and bottom view of the assembled LED light embodiment of FIG. 1.

FIG. 5A-B respectively show a rear view and a front view of the assembled LED light embodiment of FIG. 1.

FIG. 6 shows a telescoping and foldable collapsible fish landing net according to an exemplary embodiment of the present invention.

FIG. 7 is an exploded view of a portion of the collapsible fish landing net assembly of FIG. 6.

FIG. 8 shows an LED light assembly configured for being attached and removed from a net frame and for being tilted and rotated according to an exemplary embodiment of the invention.

FIG. 9 shows an LED light mounting configuration for being attached and removed from a net frame and for being tilted and rotated according to an exemplary embodiment of the invention.

FIG. 10 is a schematic diagram of an LED light assembly according to an embodiment of the invention.

FIG. 11 is a schematic diagram of an LED light assembly according to an embodiment of the invention.

### DETAILED DESCRIPTION OF PREFERRED EMBODIMENTS

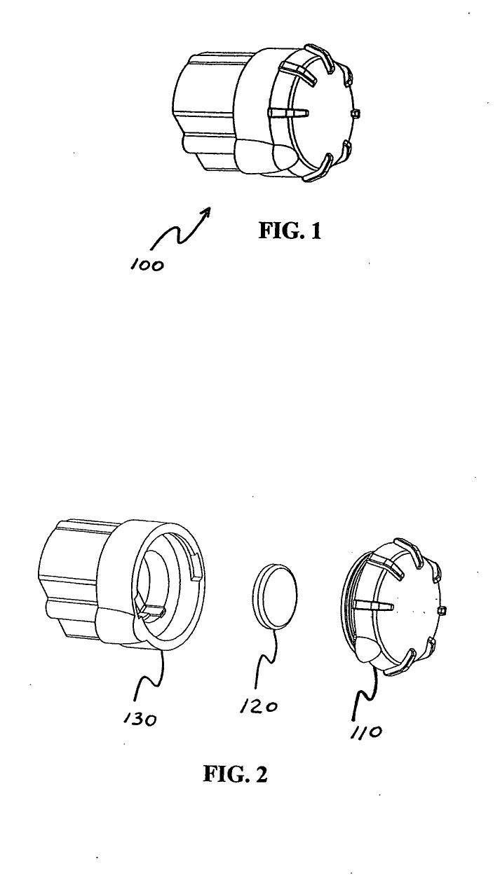

An exemplary LED light assembly 100 is shown in FIGS. 1-5B. As illustrated therein, a light structure has a somewhat cylindrical form containing a lens cap assembly 110, a disc-shaped battery assembly 120, and a base assembly 130. A clear or translucent lens 101 is contained in a lens cap 108 having raised portions 102 disposed at intervals along the circumference of the lens cap 108. The raised portions 102 provide a convenient way to grip the lens cap 108 for rotation of same, as is discussed below. The lens cap 108 also has a projecting alignment member 103 for being registered with a corresponding projecting portion 133 of the base assembly 130 when the light is in a particular switch position such as, for example, being in an ON or OFF position. The lens cap 108 may be formed of a resin material such as plastic or similar composite, preferably as an injection molded piece. A quad ring 111 is snugly fit around a cylindrical back portion 104 of the lens cap 108. Variations in different applications may provide for alternate shapes and locations for the quad ring 111 or similar structure. The quad ring 111 preferably provides a watertight seal between the lens cap 108 and the base assembly 120 while still allowing a rotating of the lens cap 108. The quad ring 111 may be formed to provide a slight urging force against the lens cap 108 to assure a fit that is not sloppy or loose.

An LED 112 is inserted into an LED cartridge 105 that has one or more lateral projection(s) 106. The lateral tooth-like projection 109 is mated with a corresponding notch (not shown) in the back of the lens cap 108 so that the lens cap 108, LED 112, and LED cartridge 105 all rotate as a unitary structure. One or more stop members 106 may be provided along a circumferential edge of the LED cartridge 105 for limiting rotation of the lens cap assembly 110 to a certain angular range with respect to the base assembly 130. A light emitting portion 113 of the LED 112 is positioned at a center opening of the LED cartridge 105. The light emitting portion 113 includes an LED light source 118 formed of semiconductor materials and conductive leads. Suitable LEDs are available from Lumex, Chicago Miniature, Ledtronics, Motorola, NEC, Optrex, Panasonic, Texas Instruments, Toshiba, and others. Depending on the particular illumination requirements, standard LEDs may have an angular illumination pattern of 15, 20, 30, 45, 50, or 70 degrees, etc., and may emit light that is white, green, blue, red, violet, or other. The present inventors have determined that blue light may have a fish-calming effect. Variations may use surface mount, light pipe, or other LED form.

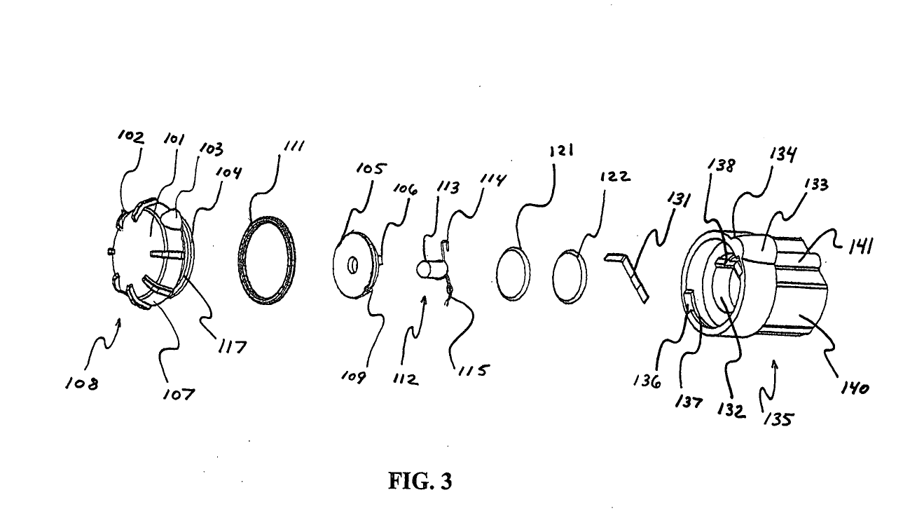

The LED 118 may have wires 115 connected to its anode and/or cathode terminals, respectively. One of the LED wires 115 may be connected at its other end, either directly or indirectly, to one terminal of a disc-shaped battery assembly 120. As shown in FIGS. 2 and 3, the disc shaped battery assembly 120 includes a first disc shaped battery 121 and a second disc shaped battery 122 disposed in series with one another. A battery assembly 120 may have any number or configuration of individual batteries or cells thereof. The other LED wire 115 is connected at its other end to a clip tab 114 formed in a “U” shape and extending laterally away from the longitudinal axis of the LED 112. The batteries 121, 122 have a 16 mm diameter and a 1.6 mm height. Suitable batteries may be a model CR1616 available from Panasonic and others.

Alternatively, the anode and cathode terminals of LED 112 may be electrically connected to a switch and battery terminal, respectively, without using wires 115. In such a case, the LED 112 may have a conductive shell portion that circumscribes the body of the LED and a contactor at an end portion in a manner, for example, similar to the electrical connections in a common lightbulb or cartridge type bulb. Many other forms and options are available for an LED 112 and electrical connection thereto, such as various sizes, numbers of emitters, cartridge shapes and materials, lenses, contactors, electrical current requirements, illumination properties, temperature characteristics, voltage characteristics, and other.

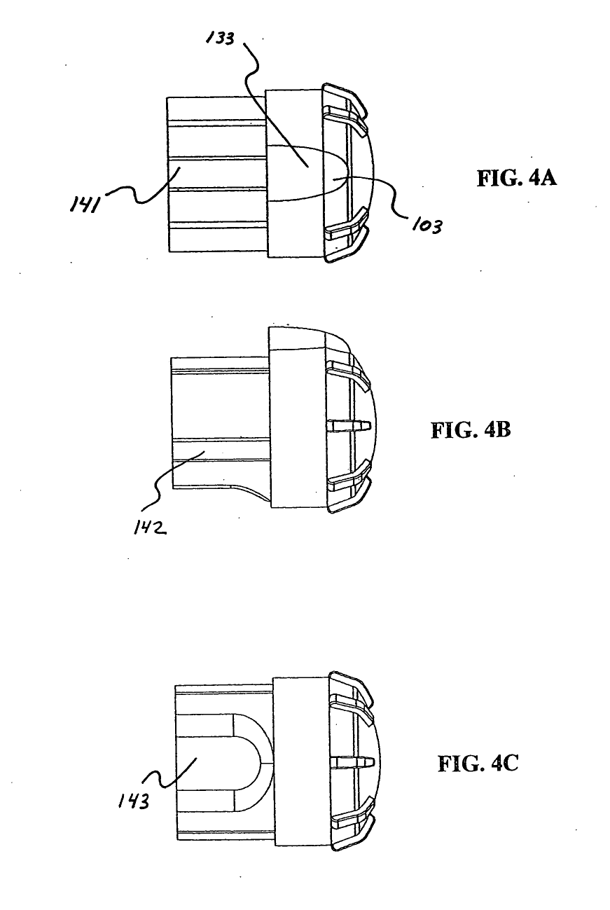

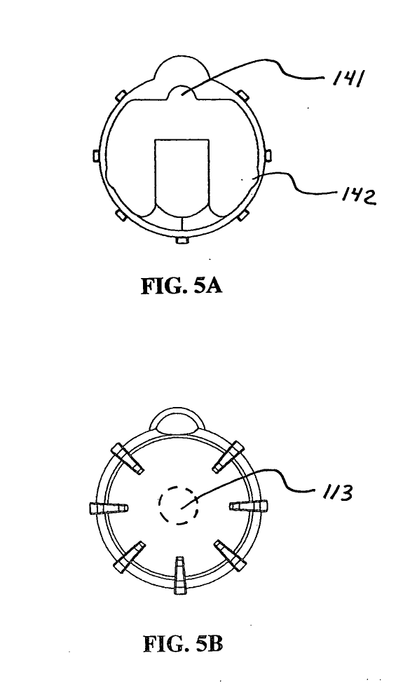

When the LED assembly 100 is assembled, an annular ridge 117, formed on the cylindrical back portion 104 of the lens cap 108, is engaged with an inner groove 137 formed in a surface of the inside portion of the base shell 135. Such engagement assures that the lens cap assembly 110 maintains proper alignment with the base assembly 130 as the lens cap assembly 110 is being rotated. When the lens cap assembly 110 is rotated, a stop member 106 rotates until it reaches a corresponding stop portion in a surface of the inside portion of the base shell 135, thereby defining an angular range of rotation for the lens cap assembly 110 with regard to the base assembly 130. Such rotation of the lens cap assembly 110 with respect to the base assembly 130 effects a switching ON or OFF of the light circuit by rotating the clip tab 114 to either abut or be separated from a contactor 131. The contactor 131 is formed of a highly conductive metal in an “L” shape that securely fits in a recess 138 formed in the inner surface of the base shell 135 as shown in FIGS. 4 and 5. The mating or unmating of the clip tab 114 with the ‘short’ leg of the contactor 131 thereby effects a rotary switch. The contactor 131 is formed to have a spring-like structure along the ‘long’ leg of the “L” for making electrical contact with the other terminal of the battery 122. The batteries 121, 122 snugly fit in a battery recess 132 formed in the inner surface of the base shell 135.

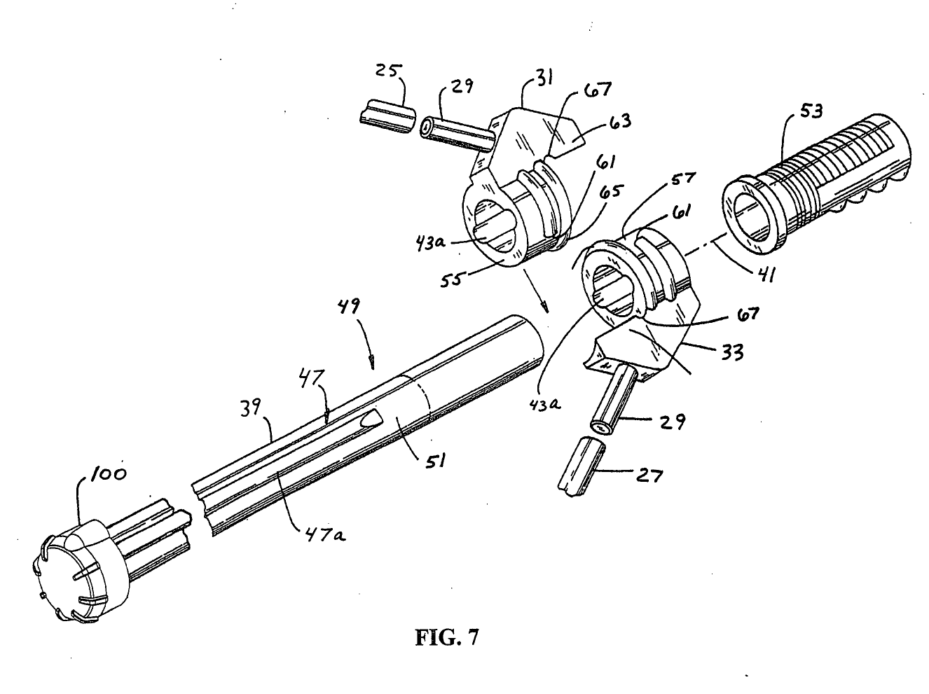

The base assembly 130 preferably has a smooth upper outer surface 134 that extends from an end portion of, for example, a shaft forming a handle of a fish landing net. The base shell 135 is preferably molded from a resinous plastic material, such as a polymer material, for example a fiber reinforced nylon plastic or an ABS plastic, polypropylene, or other similar thermoplastic or thermoset materials. FIGS. 4A-C respectively show a top view, side view, and bottom view of the LED assembly 100. The lower outer surface 140 may be formed with surface projections such as a linear raised portion 141, used for keying the base assembly 130 so it is only able to be inserted into the shaft 49 opening in one orientation (see FIG. 7), and may be used to provide a snug fit by abutting an inner wall of the opening. For example, a shaft 49 of a handle may have a projections 47, 47a having a shape corresponding to the respective shapes of the raised portions 141, 142 of the LED shell 135. In addition, as shown in FIG. 4C, a raised portion 143 is formed in a bottom of the lower outer section 140. The raised portion 143 provides a malleable surface for ensuring a tight fit of the shell 135 into the handle shaft 39.

One alternate example of a removable light assembly includes a base shell having surface projections formed as prongs so that an urging force may be applied to the prongs for releasing then from attachment to an interior surface of a handle shaft. In other words, raised portions of the shell 135 may optionally be formed as ‘spikes’ for allowing insertion of the base assembly 130 into the opening while also resisting a subsequent removal of the base assembly 130 from the handle 39. An LED base assembly may optionally be secured in the end of the handle 39 by use of any suitable structure such as, for example, a set screw, rivet, pin, spring-loaded assembly, etc. By using a number of linear projections such as projections 141, 142 along with a set screw or similar device, a secure structure of an LED assembly 100 installed in a handle 39 is obtained while also providing for easy replacement of the LED assembly 100 as a whole.

Various forms may be provided for a base assembly. For example, a generic lighting assembly may be provided for installation into fishing net handles provided in various forms by different manufacturers. Such handles may have a general cross sectional shape, such as a round hollow handle having an inner diameter within a certain range (e.g., 1.00 to 1.10 inch I.D.). By providing surface projections formed using a malleable material such as, for example, plastic or soft metal, a base assembly 130 may be ‘press-fit’ into a hollow handle or similar structure.

Another example of attaching an LED type light assembly to a fish landing net involves attaching such light assembly to the net frame 15, 17 by use of a mechanical detachable mounting arrangement such as, for example, a clip using a spring-loaded or similar urging mechanism, magnetic attachment, strap, hook and loop, unitary spring clip, bar and slot, threaded bolt with clamp, or other. One example includes a strap/band that is adjustable to allow easy removal while also providing a secure attachment. In such a case, a metal strap type similar to one commonly adapted for securing a rubber automotive hose to a nipple of a radiator outlet may be used. With such a mounting strap, the light may be loosened and removed, or tightened in place by use of a screwdriver for tightening the strap around the frame 15, 17 of a fish landing net 10. In this manner, the light may also be moved to a different location along the net frame 15, 17 such as by sliding the light along the frame 15, 17 when the strap is loosened. Similarly, an LED assembly 100 may be removably attached to a frame section 15, 17 using a simple plastic clip. One example of such a clip that may be modified for holding an LED assembly 100 is a plastic clip disclosed in U.S. Pat. No. 5,090,097, granted to Koester, Jr, et al., herein incorporated by reference. Another example of an attachment structure is a well-known C-clamp or similar device that may be easily located and tightened in a desired position along the frame 15, 17. Many other examples will be apparent to one skilled in the art.

Such an attachable light may be provided to a fisherman who is free to attach it to a net frame of his choosing and at a particular lighting location for orienting the light pattern according to his application. For example, a lefthanded or righthanded fisherman may wish to place the light at a particular net location for landing a fish while standing in waders in a stream having a strong current, may wish to place the light in a different location when approaching a hooked fish along a shoreline, may wish to place the light in a different location along the net frame 15, 17 for landing a fish while sitting or standing in a boat, may wish to move the landing net in a right-to-left direction and then later change to a left-to-right movement, etc.

In addition, a fisherman may wish to change a direction of the light without detaching and reattaching the light. Accordingly, the attachment structure for attaching an LED light to a net frame may be optionally provided with a mechanism for re-directing the light. The light may be positioned for illuminating a desired area when the net is being held in a certain orientation, for example, to avoid disturbing neighboring fishermen, to avoid scaring away of the fish being landed or neighboring fish, to add light to a shore location, to direct the light at a certain angle into the water, etc. One example of such a mechanism is commonly known for use in an AM band antenna of a portable radio. Such structure allows a user to rotate the LED light, adjust a tilt or direction, and may have a telescoping shaft. Other structures for rotating and pivoting the LED light, including use of one or more locking or tightening mechanisms for setting a light position, may be used.

FIG. 8 shows an LED light assembly 300 configured for being attached and removed from a net frame 15 and for being tilted and rotated. An LED base assembly 330 is installed in a light holder 350 pivotally mounted on a connecting piece 351 integrally formed with a C-clamp 352. A threaded portion 353 rotates inwardly or outwardly of the C-clamp 352 as the threaded portion 353 is turned by using the clamp bar 354 in a known manner. An inner end of the threaded portion 353 may optionally have a disc mounted thereon for abutting the frame section 15 when the C-clamp 352 is being tightened. A pivoting mechanism connecting the connecting piece 351 and the light holder 350 may be a conventional ball and socket type assembly as is further described below.

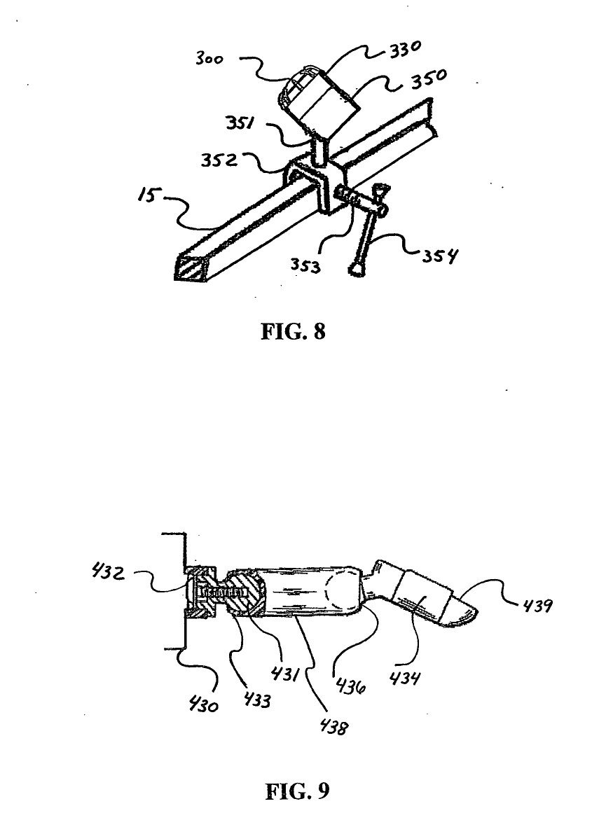

FIG. 9 shows another exemplary LED light mounting configuration for being attached and removed from a net frame 15 and for being tilted and rotated. An LED base assembly 430 is directly attached to an upper pivoting ball 431 using a threaded screw 432 or similar device. Use of a washer is preferred. The ball 431 is snugly fit in an upper socket 433 of extension portion 438. A lower ball and socket portion 436 is located at the other end of the extension portion 438 and is functionally the same as the upper ball and socket 431, 433. The tension of the socket 433 against the ball 431 may be adjusted by use of a tensioning device (not shown) such as an urging spring member, set screw, etc. The lower ball and socket portion 436 is connected to a mounting bracket 434 for attaching the assembly to a net frame. For example, a frame may have a series of holes passing through the frame, where a bolt (not shown) is passed through the frame and tightened into threaded receptacles in a mounting side 439 of the bracket 434. The above examples are intended to be non-limiting, and any suitable apparatus may be used for attaching an LED light to a frame.

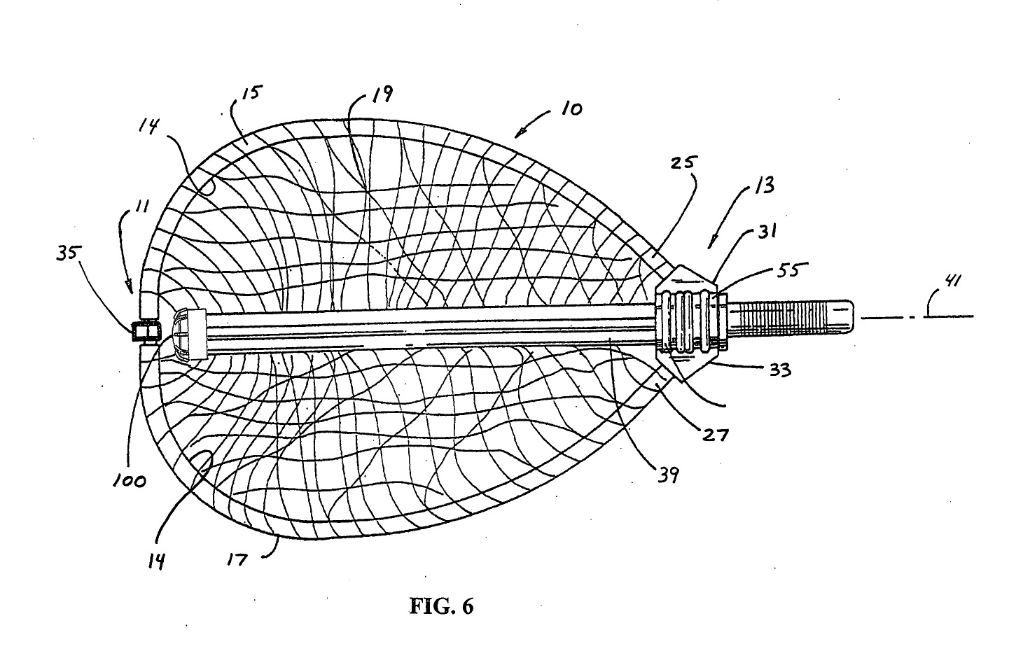

An example of a collapsible fish landing net 10 is shown in FIGS. 6 and 7, where frame members 15, 17 are joined together at a distal portion 11 and at a proximal portion 13. The frame members 15, 17 are formed as a pair of rigid, tube-like portions having symmetrical shapes. The frame members 15, 17 are threaded through the mesh netting 19 and such frame members 15, 17 are joined at the distal portion 11 by a connector assembly 35 that is adaptable to allow the frame members 15, 17 to be folded when the net assembly 10 is not in use. The connector 35 may be an elastomer having a shape memory, may be a standard hinge-like assembly, may be a rotatable type hinge assembly, may be a fastener assembly, or other. Non-limiting examples of connectors used for collapsibly connecting landing net frame members are disclosed in U.S. Pat. Nos. 5,533,293 and 5,339,556 granted to Boehm, herein incorporated by reference. The connector 35 may be provided as a locking device that resists a folding force when the net assembly 10 is in an unfolded state.

The proximal portion 13 includes apparatus that connects the two proximal ends 25, 27 of the frame members 15, 17 using lock pieces 31, 33. The lock pieces 31, 33 are respectively permanently attached to the frame members 15, 17 for slidably carrying the frame members 15, 17 along the handle assembly 39. The handle assembly 39 includes a grip 53 preferably having a surface such as one formed using a tear-resistant foam composite material that provides the fisherman with a secure place to maintain hold of the net assembly. A plastic, rubber or similar gripable material may alternatively be used. The grip 53 is formed at a proximal end of an outer shaft 49, preferably hollow and formed of a lightweight material such as aluminum, the outer shaft 49 having a ridge 47a formed along most of its length. The handle assembly in this example is formed as telescoping hollow sections so that the handle assembly 39 may be compressed in a telescoping manner to minimize the size for storage. The distal end of the handle assembly 39 has an LED light assembly 100.

The lock pieces 31, 33 may be formed so that the frame members 15, 17 attached to the lock pieces 31, 33 are able to be folded when the lock pieces 31, 33 are slidably moved to a release portion 51 of the shaft 49, the release portion 51 having a section with the ridge 47a removed. Each proximal end 25, 27 of each frame member 15, 17, respectively, may be fitted to a stud 29 projecting from each of the first and second lock pieces 31 and 33, respectively, for providing an attachment location for the two proximal ends 25, 27 of the frame members 15, 17. Each proximal end 25, 27 is thereby substantially permanently attached to a respective lock piece 31, 33. Detachment of a proximal end from its stud is not necessary when folding the net 10 because the lock pieces 31, 33 are made to rotate with respect to one another for folding the net assembly 10, when the lock pieces 31, 33 are slid into the release section 51 along the shaft 49.

The lock pieces 31, 33 each have a surface deformation formed as grooves 43a. When the net 10 is assembled for use, the groove(s) 43a of one-lock piece 31 are aligned with the corresponding groove(s) 43a of the other piece 33. The handle assembly 10 may have additional surface deformations and/or ridges 47 formed along most of its length, providing additional support against unwanted rotation of telescoping sections of the shaft assembly 49 respecting one another. When the net 10 is unfolded and the grooves 43a aligned (as described above), the handle ridges 47a engage the corresponding grooves 43a in both lock pieces 31, 33 and prevent such pieces 31, 33 from rotating with respect to one another and with respect to the handle assembly 10.

The release portion 51 of the handle assembly 10 is a substantially cylindrical section free of ridges 47a or other surface deformation 47 used to lock the pieces 31, 33 as described. Therefore, the lock piece 31 and the handle 39 are non-rotatable with respect to one another when the grooves 43a of piece 31 are engaged with the ridges 47a of the handle 39. When the handle assembly 10 is pushed inward toward the net distal portion 11, the release portion 51 becomes aligned with that lock piece 31 or 33 nearest the grip 53. Such lock piece 31 or 33 is thereby no longer prevented by the handle ridges 47a from rotating with respect to the handle 39, and for net folding, the lock piece 33 and the attached frame member 25 may be rotated with respect to the handle assembly 10 and the lock piece 31.

It is to be appreciated that the lock pieces 31, 33 may be configured so that the ring portion 55 of lock piece 31 is nearer the grip 53 than is the ring portion 57 of lock piece 33. In such a case, ring portion 55 turns with respect to the handle 39 but portion 57 does not. In an alternate embodiment, lock pieces 31, 33 may be configured so that the ring portion 57 of lock piece 33 is nearer the grip 53 than is the ring portion 55 of lock piece 31. In such a case, ring portion 57 turns with respect to the handle 39 but portion 55 does not.

It is also to be appreciated that the above-described “groove-and-ridge” arrangement is but one possible structure. Rather than having ridges 47a, the handle 39 may instead have any one of several “key-like” cross-sectional shapes, i.e., shapes that function like a shaft key in preventing relative rotation of two parts. For example, square, hexagon, oval, splined, or other handle cross-sectional shapes may be used. Any such shapes may be adapted to prevent relative rotating movement of adjacent parts, e.g., handle 39 and lock pieces 31, 33, with respect to one another.

The first lock piece 31 includes a stop member 61 and the second lock piece 33 includes a stop surface 63 in contact with the stop member 61 when the net 10 is erected for use. In one collapsible net, each lock piece 31, 33 has a stop member 61 and a stop surface 63. When the net 10 is unfolded ready for use, the stop member 61 of the first lock piece 31 contacts the stop surface 63 of the second lock piece 33. Similarly, the stop member 61 of the second lock piece 33 contacts the stop surface 63 of the first lock piece 31. The stop members 61 and surfaces 63 are arranged in a way that when such stop surfaces 63 contact their respective stop members 61, the grooves 43a in the lock pieces 31, 33 are aligned with one another so that the handle can slide in such lock pieces 31, 33 for net folding or setup.

In addition, the lock pieces 31, 33 may be configured so that they are relatively axially immovable one with respect to the other. To that end, at least one lock piece e.g., piece 31, has a circumferentially-extending land 65 engaging a notch 67 in the other lock piece 33. Each lock piece 31, 33 may have such a land 65 and notch 67.

The above-described collapsible net assembly and variations thereof is but one type of collapsible landing net assembly. Alternate structures may be used with the present invention, such as structures that fold, that pull apart, that contain various hinge devices, etc. Various other structures may be alternatively used for providing a collapsible net adaptable to attaching an LED light 10 in different locations. For example, a net may be provided with additional leg members, attachment hook, rope sling, etc. (not shown) for using the landing net assembly as a light source in a tripod standup position, hanging position, etc., for illuminating a fish cleaning area, picnic area, or other.

It may also be desirable for a fisherman to customize his lighting by controlling a brightness level for light being emitted by the LED light. Many different methods and structures may be employed for changing a brightness of an illuminator such as an LED type lighting apparatus. One example of a controller for changing LED brightness is disclosed in U.S. Pat. No. 6,132,072, granted to Turnbull et al., herein incorporated by reference. A simple example is a use of a number of individual LED emitters such as a known structure having the individual emitters configured in a ring. By switching on only some of the emitters, a lower brightness may be obtained, as a whole, from the apparatus. The switching may utilize a multiple-position switch adapted for connecting different groups of the emitters to an electric source when the switch is at a given one of the multiple positions. An LED cartridge may be obtained in various single and multiple emitter configurations, for example, from Luxeon. Another example includes using mixed illumination from emitters having different hues such as by the illuminator assembly disclosed in U.S. Pat. No. 6,523,976 granted to Tumbull et al., incorporated by reference. Another example is a use of a modulation scheme such as pulse width modulation (PWM) for changing on time of individual pulses. Frequency of an LED drive signal may also be modulated for changing brightness level. A microprocessor may be provided to control brightness of an LED light, when only the best is acceptable for the discriminating fisherman. Such a processor allows implementation of virtually limitless brightness level selection. Drive signals for the LED may also be used for setting or changing the color of the emitted light. By controlling the brightness, a fisherman may select an illumination level based on the amount of moonlight, an adaptation of the fisherman's eyes to the darkness, a desire to avoid scaring away of fish, a need for greater illumination, etc.

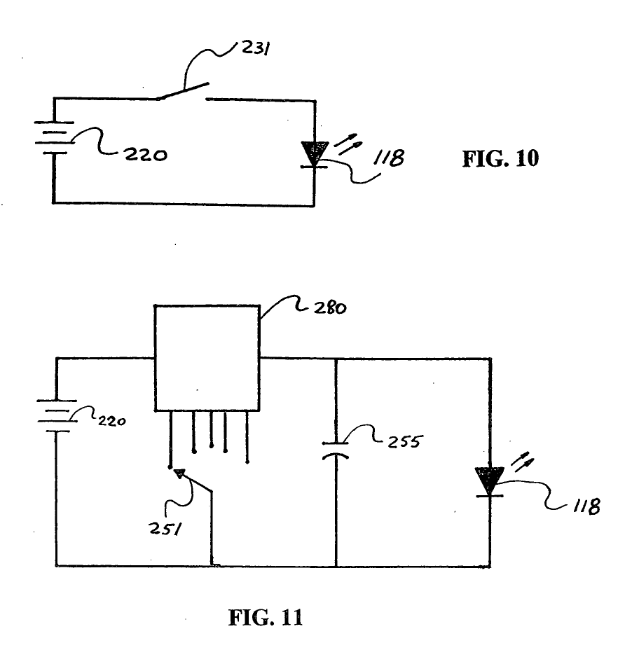

FIGS. 10-11 show exemplary circuits that may be utilized for driving the LED 112. The configuration of an LED light assembly 100 described above effects a most simple arrangement as shown in FIG. 10, where an electrical source 220 has one of its terminals connected to the LED 113 through a single pole single throw switch 231. For the exemplary embodiment of FIG. 3, the electrical source includes batteries 121, 122, and the switch 231 includes clip tab 114 and contactor 131. The alternate circuit of FIG. 11 includes a controller/driver 280 optionally incorporating various LED control elements such as at least one switching transistor, voltage conversion circuitry, an inductor, diodes, a microprocessor, resistors, etc. For example, various LED drivers are disclosed in U.S. Pat. No. 6,359,392 granted to He and U.S. Pat. No. 6,305,818 granted to Lebens et al., both herein incorporated by reference. In the FIG. 11 example, a multiple-position switch 251 selectively connects a voltage to one of a number of select inputs to the controller/driver 280. Depending on the input being selected, the controller/driver 280 controls, for example, the current being supplied to the LED 118 by a modulation technique such as pulse width modulation (PWM). An alternate form for the switch 251 is a use of a pair of touch membrane type buttons in the form of an up arrow button and a down arrow button for incrementally adjusting the brightness of the LED 118 by PWM control. Any suitable switch and driver may be used. A capacitor 255 and/or other similar components such as inductor(s) may be added to the LED drive circuit for providing noise immunity, spike reduction, etc.

Light being emitted from LED assembly 100 may be adapted for providing light emission having a hue such as blue that may avoid scaring away of fish or even provide a somewhat calming effect for fish. As noted above, the light may be adapted for mixing hues, and can also be configured with a switch for changing among a selection of different hues, for example, to experiment with the effect of such lighting variation on fish, on neighboring fishermen, on moods of the fishing party, etc.

The light emission from one or more LEDs 118 may also be directed to various surfaces on the fishing net. Such surfaces may contain reflecting materials, phosphors, pigments, light absorbing or diffracting materials, etc., and the surfaces may be patterned to obtain various effects beneficial to the fisherman. For example, the lens 101 may be adapted for providing a degree of focusing of the emitted light onto one or more reflective surfaces located along the inner portion 14 of the frame sections 15, 17 at a position opposing the LED light 100 when the net frame 15, 17 is in an in-use position. The reflecting surface 14 may contain fluorescent pigments that absorb incident radiation and produce an emission having altered properties. The reflecting surface 14 may be formed to provide light mixing properties for achieving a combined effect from a light pattern generated by the LED light 100 alone and a light pattern produced by light being reflected off the reflecting surface 14. The reflecting surface 14 may be provided as a coating applied directly to the frame 15, 17, as a tape that may be applied to selected portions of the frame 15, 17, etc. One example of a suitable type of reflective material is a reflective tape available under the trade designation NIKALITE and manufactured by Nippon Carbide Industries (ISA), Inc. Another example of a reflective tape is one distributed by Nadco Inc. of Dover N.H. Such tape, for example, may be formed of multiple layers and have an adhesive side and a color side. A thickness of the tape may be 0.0055 inches (0.1397 mm), including a liner and an adhesive. A width and length of the tape will vary according to a particular application. A reflective surface disposed on one or more frame sections of a fish landing net and opposed to the LED light 100 causes a resulting illumination pattern to be produced by the combination of direct light being emitted from the LED light 100 and reflected light produced by the reflecting surface as a result of light received by the reflecting surface.

Similarly, the combined lighting effect may be modified by various uses of pigments including but not limited to fluorescent and phosphor type materials. Such pigments may be patterned to replicate a fish coloring and/or a fish-friendly environment. An illumination effect may thereby avoid scaring away of fish. By way of example, various uses of laminate structures with different pigments are disclosed in U.S. Pat. No. 6,416,853 granted to Nakashima et al., incorporated herein by reference, where color-change laminates provide water adhesion that results in visual changes to an article.

The illumination may itself be provided using a variety of different types of LEDs 112 that generate light of different hues and spectral content. The LED 118 itself may have a light emission of a particular color, and a lens may also be an integral part of the LED 112. LEDs are essentially semiconductors that emit narrow spectrum light when a high current is passed through a p-n junction. The output wavelength is primarily determined by the bandgap of the semiconductor and corresponds to a wavelength of approximately 400 nm to 780 nm in the visual spectrum. Varying a drive signal to the LED 118, then, may effect a change in color of emitted light. Alternatively, by using an integral colored lenscap, an apparent color is modified by filtering or enhancing the contrast of the LED 112.

The reflecting surface 14 may be covered with a filter material for further modifying the effect(s) produced by combinations of patterns, colors, and dimensions thereof. For example, an optical filter is capable of transmitting light of one excitation type and of preventing transmission of light of another type, for example, a type being emitted by the LED 112. Various film layers may be applied to a surface to prevent glare, to create a blue shift (i.e., a shift of spectral peaks toward the blue end of the spectrum as angle of incidence is varied) or similar color shift, for polarizing or non-polarizing, etc. For example, U.S. Pat. No. 6,531,230 granted to Weber et al., incorporated herein by reference, discloses a specially dimensioned broadband mirror film used in combination with other films to introduce slack into the broadband mirror film. The resulting film reflects various hues of blue due to the differing angles of incidence provided by the mirrored substrate, to produce a rippled appearance not unlike the surface of a body of water.

The combined effect of a reflecting surface 112 and an LED light 100 may be further enhanced by utilizing patterns of pigments that replicate a fish-friendly environment such as by simulating an environment having a calming effect on a fish. Preferably, a pattern of pigments is adapted to make a task of landing a fish easier. Such a pattern may include a spatial arrangement of the pigments and/or optical filter elements that provides a two-dimensional or three-dimensional effect customized for simulating particular aquatic environments. An experienced fisherman may experiment with effects produced by mixing and matching different frames 15, 17, tapes, etc. that provide different lighting effects, such as by replicating a pattern of colors and fluorescence of a particular type of fish. Different frames and tape coverings may be provided as optional accessories or as replacement parts, allowing the fisherman to select and/or create a particular lighting effect of his choosing, or they may be provided in a configuration set by the manufacturer. It may be advantageous to create, for example, what the fisherman believes to be an illumination environment conducive to the mating of fish, such as during a salmon running season. Other applications for creating various effects may be implemented to enhance various aspects of a landing of fish.

While the principles of the invention have been shown and described in connection with specific embodiments, it is to be understood that such embodiments are by way of example and are not limiting.

1. A light adapted to be used with a fish landing net comprising:
at least one light emitting diode (LED);
a base member structured to hold the LED; and
a switch for connecting or disconnecting a circuit to the LED,
wherein the base member is attachable to the fish landing net.

2. The light of claim 1 wherein the switch comprises a rotatable member mounted on the base member, the connecting or disconnecting a circuit to the LED being effected by a rotating of the rotatable member.

3. The light of claim 2 wherein the rotatable member is a transparent cover.

4. The light of claim 2 wherein the circuit comprises a battery, a voltage from the battery being connected or disconnected to the LED by a rotation of the rotatable member.

5. The light of claim 2 wherein the base member includes a first contact and the rotatable member includes a second contact, the first and second contacts being engaged with one another in a connecting position of the rotatable member and being disengaged with one another in a disconnecting position of the rotatable member.

6. The light of claim 2 wherein the base housing has a light-emitting end with an annular groove, and wherein the rotatable member has an annular ridge structured to fit within the annular groove.

7. The light of claim 1 wherein, for a fish landing net having a handle, the base member is formed to be fitted inside an end of the handle.

8. The light of claim 1 wherein, for a fish landing net having a handle, the base member is formed to be fitted around an end of the handle.

9. The light of claim 1 wherein, for a fish landing net having a frame for securing a web, the base member is formed to be attachable to the frame.

10. The light of claim 1 further comprising a lens disposed in a distal end of the base housing, wherein the base housing includes at least one battery contact on an inner surface of the base housing, the at least one light-emitting diode (LED) being disposed in the base housing and positioned for emitting light through the lens.

11. The light of claim 9 wherein the lens is formed to direct the emitting light.

12. The light of claim 1 further comprising a battery.

13. The light of claim 12 wherein the battery is disc-shaped.

14. The light of claim 1 wherein a brightness of the LED is set to a level of non-disturbance of a fish.

15. The light of claim 1 wherein the switch has a plurality of switch positions for switching the light to a corresponding plurality of brightness levels, the light further comprising an illumination level control member structured to change brightness of the light according to the switch positions.

16. The light of claim 1 structured to provide a watertight seal for an interior portion of the base housing.

17. The light of claim 1 wherein the at least one LED comprises a disc-shaped cartridge.

18. The light of claim 1 wherein the switch is disposed locally to the base member.

19. A light adapted to be used with a fish landing net comprising:
at least one light emitting diode (LED);
means for holding the LED; and
means for switching a connection to the LED on or off.

20. Fish landing apparatus comprising:
a net structure for landing fish and having an electric-powered illuminator; and
a switch disposed locally to the illuminator.

21. The apparatus of claim 20 wherein the net structure includes a handle member and the illuminator is inserted in a distal end of the handle member.

22. The apparatus of claim 20 wherein the net structure includes a handle member and the illuminator is adapted to fit around a distal end of the handle member.

23. The apparatus of claim 20 wherein the net structure includes a frame for holding a web, and the illuminator is adapted to be attachable to the frame.

24. The apparatus of claim 20 wherein the net structure comprises at least one frame member having a surface opposed to the illuminator and having disposed on the surface at least one of reflective tape and reflective coating.

25. The apparatus of claim 24 wherein the at least one of reflective tape and reflective coating contains fluorescent pigment.

26. The apparatus of claim 25 further comprising an optical filter for filtering light emitted by an excitation of the fluorescent pigment.

27. The apparatus of claim 24 wherein the at least one of reflective tape and reflective coating contains pigment replicating a fish-friendly environment.

28. The apparatus of claim 24 wherein the at least one of reflective tape and reflective coating contains a pigment in a pattern that replicates a fish-friendly environment.

29. The apparatus of claim 28 wherein the pattern has a spatial arrangement comprising one of two-dimensional and three-dimensional.

30. The apparatus of claim 24 wherein the illuminator comprises a light beam shaper for focusing a light beam emitted from the illuminator on the at least one of reflective tape and reflective coating.

31. Fish landing apparatus comprising:
a collapsible net for landing fish, the collapsible net including a handle member; and
an electric-powered illuminator disposed in a distal end of the handle member.

32. The apparatus of claim 31 wherein the collapsible net comprises two hinged frame members.

33. A method facilitating the landing of fish comprising:
providing apparatus that includes a net structure for landing fish and having an electric-powered illuminator, and a switch disposed locally to the illuminator; and
changing a level of illumination of the illuminator from a first brightness level to a second brightness level.

34. A method facilitating the landing of fish comprising:
providing apparatus that includes a net structure for landing fish and having an electric-powered illuminator, and a switch disposed locally to the illuminator; and
adjusting a light emission of the apparatus for avoiding scaring-away of fish.

35. A method facilitating the landing of fish comprising:
providing apparatus that includes a net structure for landing fish and having an electric-powered illuminator, and a switch disposed locally to the illuminator; and
setting a light emission of the apparatus for avoiding scaring-away of a particular type of fish.

36. A method facilitating the landing of fish comprising:
providing apparatus that includes a net structure for landing fish and having an electric-powered illuminator operable to emit light in a pattern, the illuminator being positionable for changing a direction of the pattern.
